(19) United States
(12) Patent Application Publication
(10) Pub. No.: US 2025/0145478 A1
(43) Pub. Date: May 8, 2025

(54) METHODS FOR MAKING ZEOLITE-Y PARTICLES

(71) Applicant: Saudi Arabian Oil Company, Dhahran (SA)

(72) Inventors: Faisal Alotaibi, Al-Khobar (SA); Lianhui Ding, Dhahran (SA)

(73) Assignee: Saudi Arabian Oil Company, Dhahran (SA)

(21) Appl. No.: 18/500,513

(22) Filed: Nov. 2, 2023

(51) Int. Cl. C01B 39/24; B01J 6/00; B01J 29/08; B01J 37/06; B01J 37/08

(52) U.S. Cl. CPC C01B 39/24; B01J 6/001; B01J 29/084; B01J 37/06; B01J 37/08; C01P 2004/60; C01P 2006/12; C01P 2006/14

(57) ABSTRACT

A method for making zeolite-Y particles may include forming an initial zeolite precursor solution including an initial alumina source material and a silica source material in a solvent. The method may also include heating the initial zeolite precursor solution at a temperature of at least 50° C. to form an intermediate mixture. The method may also include adding additional alumina source material to the intermediate mixture. Following the adding of the additional alumina source material to the intermediate mixture, the intermediate mixture may be heated at a temperature of at least 50° C. to form zeolite-Y particles.

### FIELD

The embodiments described herein generally relate to porous materials and, more particularly, to zeolites.

### BACKGROUND

Materials that include pores, such as zeolites, may be utilized in many petrochemical industrial applications. For instance, such materials may be utilized as catalysts in a number of reactions that convert hydrocarbons or other reactants from feed chemicals to product chemicals. Zeolites may be characterized by a microporous structure framework type. Various types of zeolites have been identified over the past several decades, where zeolite types are generally described by framework types, and where specific zeolitic materials may be more specifically identified by various names such as ZSM-5 or zeolite-Y.

Zeolite-containing catalysts and adsorbents have widespread uses in many diverse industries. Exemplary industries include the petrochemical industry in refinery, gas separation, and carbon dioxide separation and capture processes. In the petroleum industry, for example, zeolite-containing catalysts may be included in processes such as fluid catalytic cracking (FCC) and hydrocracking to catalyze reactions such as hydrogenation, dehydrogenation, isomerization, alkylation, and cracking, for example. Additionally, zeolite-containing adsorbents may be utilized in the separation of paraffins or aromatic isomers, and in drying processes to remove water and other impurities from hydrocarbon streams.

### SUMMARY

Embodiments of the present disclosure are directed to methods of making zeolite-Y particles. In particular, the methods of making zeolite-Y particles described herein may comprise forming a zeolite precursor solution, heating the zeolite precursor solution, adding additional alumina source material, and heating the mixture after the addition of the additional alumina source material. It has been discovered that the adding of additional of alumina source material after the first heating but before the second heating may improve the overall yield zeolite-Y produced when compared to methods that do not add additional alumina source material between the first and second heating steps. Accordingly, the methods of the present disclosure may have higher yield, reducing the cost of synthesizing the zeolite-Y.

According to one or more embodiments, a method for making zeolite-Y particles may comprise forming an initial zeolite precursor solution comprising an initial alumina source material and a silica source material in a solvent. The method may also comprise heating the initial zeolite precursor solution at a temperature of at least 50° C. to form an intermediate mixture. The method may also comprise adding additional alumina source material to the intermediate mixture. Following the adding of the additional alumina source material to the intermediate mixture, the intermediate mixture may be heated at a temperature of at least 50° C. to form zeolite-Y particles.

It is to be understood that both the preceding general description and the following detailed description describe various embodiments and are intended to provide an overview or framework for understanding the nature and character of the claimed subject matter. Additional features and advantages of the embodiments will be set forth in the detailed description and, in part, will be readily apparent to persons of ordinary skill in the art from that description, which includes the accompanying drawings and claims, or recognized by practicing the described embodiments. The drawings are included to provide a further understanding of the embodiments and, together with the detailed description, serve to explain the principles and operations of the claimed subject matter. However, the embodiments depicted in the drawings are illustrative and exemplary in nature, and not intended to limit the claimed subject matter.

### BRIEF DESCRIPTION OF THE DRAWINGS

The following detailed description of specific embodiments of the present disclosure can be best understood when read in conjunction with the following drawing, in which:

FIG. 1 depicts a micrograph of zeolite-Y particles, according to one or more embodiments described herein.

Reference will now be made in greater detail to various embodiments, some embodiments of which are illustrated in the accompanying drawing.

### DETAILED DESCRIPTION

One or more embodiments presently described herein are directed to methods of making zeolite-Y particles. In some embodiments, the zeolite-Y particles are nano-sized, as described herein. In general, alumina source material is added both before and after a heating step, resulting in increased yields, according to some embodiments. More specifically, according to the methods for making zeolite-Y particles described herein, a zeolite precursor solution may be formed and the zeolite precursor solution may be heated. Following the heating, additional alumina source material may be added to the mixture, and the mixture may be heated following the addition of the additional alumina source material. These steps are discussed in detail hereinbelow.

As used throughout this disclosure, “zeolites” or “zeolite materials” generally refer to micropore-containing inorganic materials with regular intra-crystalline cavities and channels of molecular dimension, as would be understood by those skilled in the art. Zeolites generally comprise a crystalline structure, as opposed to an amorphous structure. The microporous structure of zeolites may render large surface areas and desirable size-/shape-selectivity, which may be advantageous for catalysis. Accordingly, zeolites may be utilized in many petrochemical industrial applications, such as, for instance, reactions that convert hydrocarbons or other reactants from feed chemicals to product chemicals by cracking.

Generally, zeolites may be characterized by a microporous framework type, which defines their microporous structure. Framework types are described in, for instance, “Atlas of Zeolite Framework Types” by Christian Baerlocher et al., Sixth Revised Edition, published by Elsevier, 2007, the teachings of which are incorporated by reference herein.

As described herein, the zeolites formed are zeolite-Y. Zeolite-Y generally comprises an FAU framework type. Zeolite-Y described herein may be characterized, in some embodiments, as ultra-stable zeolite-Y (USY). As used herein, “zeolite-Y” and “USY” refer to a zeolite having a FAU framework type according to the IZA zeolite nomenclature and consisting majorly of silica and alumina, as would be understood by one skilled in the art.

As described hereinabove, in one or more embodiments, in an initial step, a zeolite precursor solution may be formed. Generally, zeolite precursor solutions may refer to those that include the materials that will form the zeolite, such as silicon, aluminum, and oxygen atoms. Zeolite precursor solutions may include a solvent and at least an initial alumina source material and a silica source material. As described herein, the “initial alumina source material” is described as initial since more will be added in later steps, referred to as the “additional alumina source material.” In general, the “initial alumina source material” may be utilized before the first heating step, and the “additional alumina source material” maybe be utilized after the first heating step, as is described in detail herein. The zeolite precursor solution may further comprise a basic compound, as described herein. The solvent may be water, but other solvents are not necessarily excluded from the scope of the presently disclosed methods.

Without limitation, the initial alumina source materials may comprise one or more of NaAlO₂, Al₂(SO₄)₃, Al(NO₃)₃, AlCl₃, or Al₂O₃. Also, without limitation, the silica source material may comprise one or both of colloidal silica, fumed silica, or tetraethyl orthosilicate (TEOS), or Na₂SiO₃. It should be understood that molecules of source materials may disassociate in solution, and that the initial zeolite precursor solution comprising an alumina source material or a silica source material may refer to the initial zeolite precursor solution comprising the initial molecules of the source materials or disassociated components of these molecules. The basic compound may be chosen from NaOH, KOH, Mg(OH)₂, and the basic compound composition is not necessarily limited. In some embodiments, the alumina source material may not be aluminum isopropoxide.

According to one or more embodiments, the zeolite precursor solution may generally be prepared by mixing the initial alumina source material and the silica source material into a solvent. For example, the initial alumina source material may be mixed into a solvent, the silica source material may be mixed into another solvent, and these two mixtures may be combined. The ordering of combination of the mixing of the initial alumina source material and the silica source material into the solvent is not necessarily limited. Similarly, a basic compound may be mixed into the solution that includes the initial alumina source material and silica source material, or may be added already mixed with the solvent.

According to one or more embodiments, the mixture that includes the initial alumina source material and silica source material may be aged to form the zeolite precursor solution. Aging may be for a period of time of at least 10 hours, such as from 10 hours to 48 hours, from 10 hours to 30 hours, or from 15 hours to 25 hours. The aging may include agitating the mixture, such as stirring the mixture. In some embodiments, the aging may be at an elevated temperature, such as about 30° C., but in other embodiments the aging may be at ambient temperature such as about 25° C. Without being bound by theory, while it is not believed that the overall chemical composition substantially changes in the mixture during aging, it is believed that aging may form zeolite nuclei from which zeolitic particles may be formed in downstream steps by crystallization. In general, final crystal sizes may be smaller when more nuclei are formed during aging, and relatively small crystal size and particle size may be desired.

In one or more embodiments, the molar ratio of components in the initial zeolite precursor solution may be 8-12 Na₂O:1 Al₂O₃:8-16 SiO₂:200-400 H₂O. Molar ratios of any two of these components are contemplated herein based on the described molar ratio of Na₂O, alumina, silica, and water.

In one or more embodiments, the method of making zeolite-Y particles may exclude the use of an organic structure-directing agent, which in conventional embodiments, may be incorporated into the zeolite precursor solution. For example, the method may not utilize one or more of tetraethylammonium cation, N,N-dimethyl-2,6-cis-dimethylpiperdinium cation, dimethyldiisopropylammonium cation, N,N,N-trimethylcyclohexanaminium cation, N-ethyl-N,N-dimethylcyclohexanaminium cation, N-isopropyl-N-methyl-pyrrolidinium cation, N-isopentyl-N-methyl-pyrrolidinium cation, and N-isobutyl-N-methyl-pyrrolidinium cation. Without being bound by theory, it is believed that the methods of making zeolite-Y particles of the present disclosure that do not utilize an organic structure-directing agent may be less costly than comparable methods of making zeolite-Y particles that do utilize an organic structure-directing agent.

Following the forming of the initial zeolite precursor solution, the initial zeolite precursor solution may be heated. According to one or more embodiments, the initial zeolite precursor solution may be heated at a temperature of at least 50° C., such as from 50° C. to 70° C. For example, the heating may be at a temperature of from 50° C. to 55° C., from 55° C. to 60° C., from 60° C. to 65° C., from 65° C. to 70° C., or any combination of one or more of these ranges. In one or more embodiments the heating may be for a timer period of from 12 hours to 24 hours, such as from 12 hours to 14 hours, from 14 hours to 16 hours, from 16 hours to 18 hours, from 18 hours to 20 hours, from 20 hours to 22 hours, from 22 hours to 24 hours, or any combination of one or more of these ranges. Without being bound by theory, it is believed that during this heating step precursor nuclei may form. It is also believed that by heating the initial zeolite precursor solution at a temperature of from 50° C. to 70° C. the initial zeolite precursor solution may be maintained in an amorphous state without significant crystal growth.

According to one or more embodiments, following the heating of the initial zeolite precursor solution to form the intermediate mixture, additional alumina source material may be added to the intermediate mixture. In one or more embodiments the additional alumina source material may comprise one or more of, NaAlO₂, Al₂(SO₄)₃, Al(NO₃)₃, AlCl₃, NaAlO₂, or Al₂O₃. In one or more embodiments, the additional alumina source material added to the intermediate mixture may have the same composition as the initial alumina source material. In other embodiments, the additional alumina source material may have a different composition than the initial alumina source material. In one or more embodiments, the same amount of additional alumina source material may be added to the intermediate mixture as the amount of initial alumina source material added to form the initial zeolite precursor solution. In one or more embodiments, the additional alumina source maybe added in an amount necessary to reach a molar composition of the components in the intermediate mixture that matches the molar composition of the initial zeolite precursor solution (e.g., 8-12 Na₂O:1 Al₂O₃:8-16 SiO₂:200-400 H₂O).

Without being bound by theory, it is believed that the addition of alumina source material after heating the initial zeolite precursor solution may increase the final yield of zeolite-Y. It is believed that during the heating the initial zeolite precursor solution may begin to form zeolite-Y crystals. Adding additional alumina source material after the initial formation of zeolite-Y crystals may form zeolite-Y particles with a smaller particle size than if the additional alumina was added before the heating. Accordingly, it is believed that by adding additional alumina source material after the heating may result in an increased yield of nano-sized zeolite-Y particles when compared to methods of forming zeolite-Y that do not add additional alumina after the first heating.

After the addition of the additional alumina source, the intermediate mixture may be heated at a temperature of at least 50° C. For example, the intermediate mixture may be heated at a temperature of from 80° C. to 120° C., such as from 80° C. to 85° C., from 85° C. to 90° C., from 90° C. to 95° C., from 95° C. to 100° C., from 100° C. to 105° C., from 105° C. to 110° C., from 110° C. to 115° C. from 115° C. to 120° C., or any combination of one or more of these ranges. In one or more embodiments, the intermediate mixture may be heated for a time period of from 12 hours to 24 hours, such as from 12 hours to 14 hours, from 14 hours to 16 hours, from 16 hours to 18 hours, from 18 hours to 20 hours, from 20 hours to 22 hours, from 22 hours to 24 hours, or any combination of one or more of these ranges.

In one or more embodiments, the heating of the intermediate mixture solution forms the crystalized zeolite-Y particles in a residual liquid solution. In one or more embodiments, following the formation of the zeolite-Y particles in residual liquid solution, the zeolite-Y particles are separated from the residual liquid solution. Separation may be by a wide variety of techniques, and generally phase separation techniques may be suitable since the zeolite-Y particles are solids and the residual liquid solution is a liquid. For example, centrifugation may be utilized to separate the zeolite-Y particles from the residual liquid solution. Separation of the zeolite-Y particles may be complete or incomplete where, for example, some small amount of zeolite-Y particles remain in the residual liquid solution, but this is not desirably the case.

Following separation of the zeolite-Y particles from the residual liquid solution, the zeolite-Y particles may be washed and/or dried. Washing may be with water, and may be conducted until the pH of the zeolite-Y particles is from about 8 to 9. Drying may be by presence in ambient conditions or by heating, such as relatively low temperature heating. Following drying, the zeolite-Y particles may be calcinated by exposure to heat. The calcination may be performed by exposure to temperatures of from 300° C. to 500° C. for 4 to 10 hours.

As described herein, the zeolite-Y is formed as particles. The particles may be shaped particles, such as spheres, or may be inconsistent in shape or otherwise globular in shape, and shape of the particles is not necessarily limited in embodiments described herein. As described herein, the size of a particle refers to the maximum length of a particle from one side to another, measured along the longest distance of the particle. For example, a spherically shaped particle has a size equal to its diameter, or a rectangular prism shaped particle has a maximum length equal to the hypotenuse stretching from opposite corners. Particle size may be measured by a variety of known techniques such as laser diffraction analysis or microscopy. In one or more embodiments, the zeolite-Y particles may be nano-sized meaning that they have an average particle size of less than 1 micron. In some embodiments, the zeolite-Y particles may have an average diameter of from 150 nm to 280 nm, such as from 150 nm to 160 nm, from 160 nm to 170 nm, from 170 nm to 180 nm, from 180 nm to 190 nm, from 190 nm to 200 nm, from 200 nm to 210 nm, from 210 nm to 220 nm, from 220 nm to 230 nm, from 230 nm to 240 nm, from 240 nm to 250 nm, from 250 nm to 260 nm, from 260 nm to 270 nm, from 270 nm to 280 nm, or any combination of one or more of these ranges.

In one or more embodiments, the zeolite-Y particles described may include, in addition to micropores (present in the microstructure of a zeolite), mesopores, and the zeolite-Y particles may be mesoporous by having an average pore size of greater than 2 nm and less than or equal to 50 nm. Unless otherwise described herein, the “pore size” of a material refers to the average pore size, but materials may additionally include mesopores having a particular size that is not identical to the average pore size. The average pore size of a material can be measured using BET analysis, as is widely understood to those in the art. According to one or more embodiments, the zeolite-Y particles may have an average pore size of greater than 2 nm, such as from 2 nm to 5 nm, such as from 2 nm to 2.5 nm, from 2.5 nm to 3 nm, from 3 nm to 3.5 nm, from 3.5 nm to 4 nm, from 4 nm to 4.5 nm, from 4.5 nm to 5 nm, or any combination of one or more of these ranges.

In one or more embodiments, the zeolite-Y may have an average micropore volume and/or an average mesopore volume, where the total pore volume is the sum of these two. The mesopore and micropore volumes may be calculated according to the Barrett-Joiner-Halenda (BJH) method of determining mesopore volume known to one having skill in the art. Details regarding the t-plot method and the BJH method of calculating micropore volume and mesopore volume respectively are provided in Galarneau et al., “Validity of the t-plot Method to Assess Microporosity in Hierarchical Micro/Mesoporous Materials”, Langmuir 2014, 30, 13266-13274, for example. In one or more embodiments, the zeolite-Y particles may have a total pore volume of from 0.45 ml/g to 0.7 ml/g, such as from 0.45 ml/g to 0.5 ml/g, from 0.5 ml/g to 0.55 ml/g, from 0.55 ml/g to 0.6 ml/g, from 0.6 ml/g to 0.65 ml/g, from 0.65 ml/g to 0.7 ml/g, or any combination of one or more of these ranges.

In one or more embodiments, the zeolite-Y particles may have an average surface area of at least 600 m²/g, such as at least 650 m²/g, at least 700 m²/g, or even at least 750 m²/g, as determined through the Brunauer-Emmett-Teller (BET) method (average BET surface area).

As described herein, crystallinity is a measurement of the degree of structural order in a solid. A more crystalline solid will have its atoms and molecules arranged in a more regular and periodic manner than a less crystalline solid. Crystallinity is typically determined by x-ray diffraction. A particular diffraction peak can be selected and its intensity normalized. Zeolites can be analyzed and the diffraction intensity normalized against the standard producing a relative crystallinity based on a standard zeolite structure. In one or more embodiments, the zeolite-Y particles may have a relative crystallinity based on the crystallinity of CBV-100, available from Zeolyst International, of greater than 100%.

The zeolite-Y particles described herein may be utilized alone or in combination with other materials as catalyst used in hydrocracking processes. Such a process may have at least two functions: cracking of high molecular weight hydrocarbon and hydrogenating the unsaturated molecules. However, the relatively small pore size (e.g. average pore size less than 2 nm) of most conventional zeolites Y materials in hydrocracking catalysts generally does not favor the transport of large molecules in heavy oil fractions to diffuse into the active sites located inside the zeolite. This may cause low activity, and a possible deactivation of the catalyst. Additionally, the poor diffusion efficiency of bulky molecules can be avoided by reduced zeolite particle size due to increased external surface area and shortened diffusion path of the molecules. However, the relatively small particle size of the presently disclosed zeolite-Y materials may enable for better access of reactive molecules to catalytic sites.

### EXAMPLES

The various embodiments of methods described will be further clarified by the following examples. The examples are illustrative in nature, and should not be to limit the subject matter of the present disclosure.

### Comparative Example A (CE-A)—Nano Zeolite-Y Synthesis without Additional Alumina

First 6.800 g of sodium hydroxide (NaOH) was stirred and dissolved in 39.24 g of water in a glass bottle. To this mixture 1.640 g of sodium aluminate (NaAlO₂) and 21.00 g of 40 wt. % colloidal silica was added and stirred for 1 hour. The mixture was then stirred and aged at 30° C. for 20 hours. The resulting hydrogel mixture was next placed in the same bottle used for aging and crystallized at 60° C. for 12 hours, then temperature was increased to 100° C. for 12 hours. The obtained mixture was filtrated and washed with water until its pH reached between 8 and 9. The resulting solid product was dried at 110° C. for 24 hours and then calcinated at 500° C. for 4 hours (2° C./min).

### Example 1 (EX-1)—Nano Y Zeolite Synthesis with a Second Aluminum Source

First 6.800 g of NaOH was stirred and dissolved in 39.24 g of water in a glass bottle. To this mixture 1.640 g of NaAlO₂ and 21.00 g of 40 wt. % colloidal silica was added and stirred for 1 hour. The mixture was then stirred and aged at 30° C. for 20 hours. The resulting hydrogel mixture was next placed in the same bottle used for aging and crystallized at 60° C. for 12 hours. To this mixture 1.640 g of NaAlO₂ was added and temperature was increased to 100° C. for another 12 hours. The obtained mixture was filtrated and washed with water until its pH reached between 8 and 9. The resulting solid product was dried at 110° C. for 24 hours and then calcinated at 500° C. for 4 hours (2° C./min).

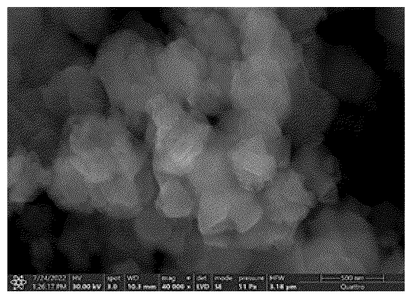

FIG. 1 depicts the average particle size of the zeolite of CE-1 and EX-1. For all Examples the particle size measurements were carried out on a scanning electron microscope (SEM).

TABLE 1
Main Properties of CE-1 and EX-1 Zeolites

| Sample Name | CE-A | EX-1 |
|---|---|---|
| Average particle sizes, nm | 200 | 200 |
| Crystallinity % | 90.0 | 85.0 |
| Bulk Si/Al, mol/mol | 1.90 | 1.60 |
| Framework Si/Al, mol/mol | 1.70 | 1.80 |
| Total surface area, m²/g | 629 | 651 |
| Micropore surface area, m²/g | 563 | 556 |
| Mesopore surface area, m²/g | 66.0 | 96.0 |
| Total pore volume, ml/g | 0.720 | 0.760 |
| Micro pore volume, ml/g | 0.300 | 0.290 |
| Mesopore volume, ml/g | 0.420 | 0.470 |
| Pore size, nm | 4.60 | 4.70 |
| Solid product Yield, wt % | 43.9 | 82.8 |

As shown in Table 1, the zeolite-Y particles produced in Example 1 showed similar or improved properties to the zeolite-Y particles produced in Comparative Example A. However, Example 1 had almost double the yield of Comparative Example A. This indicates that performing the first stage of crystallization and then adding additional alumina improves the yield of nano-sized zeolite-Y without significantly affecting the zeolite-Y particles formed.

The present disclosure includes numerous aspects. One aspect is A method for making zeolite-Y particles, the method comprising: forming an initial zeolite precursor solution comprising an initial alumina source material and a silica source material in a solvent; heating the initial zeolite precursor solution at a temperature of at least 50° C. to form an intermediate mixture; adding additional alumina source material to the intermediate mixture; and following the adding of the additional alumina source material to the intermediate mixture, heating the intermediate mixture at a temperature of at least 50° C. to form zeolite-Y particles.

Another aspect is any above aspect or combination of aspects, wherein the initial alumina source material is chosen from one or more of NaAlO₂, Al₂(SO₄)₃, Al(NO₃)₃, AlCl₃, or Al₂O₃.

Another aspect is any above aspect or combination of aspects, wherein the additional alumina source material is chosen from one or more of NaAlO₂, Al₂(SO₄)₃, Al(NO₃)₃, AlCl₃, or Al₂O₃.

Another aspect is any above aspect or combination of aspects, wherein the additional alumina source material has the same composition as the initial alumina source material.

Another aspect is any above aspect or combination of aspects, wherein the additional alumina source material has a different composition than the initial alumina source material.

Another aspect is any above aspect or combination of aspects, wherein the method does not utilize an organic structure-directing agent.

Another aspect is any above aspect or combination of aspects, wherein the heating of the initial zeolite precursor solution is at a temperature of from 50° C. to 70° C. for a time period of from 12 hours to 24 hours.

Another aspect is any above aspect or combination of aspects, wherein the heating of the intermediate mixture is at a temperature of from 80° C. to 120° C. for a time period of from 12 hours to 24 hours.

Another aspect is any above aspect or combination of aspects, wherein forming zeolite precursor solution comprises: mixing a basic compound, the silica source material, and the alumina source material into a solvent to form a mixture; and aging the mixture by stirring the mixture for at least 10 hours.

Another aspect is any above aspect or combination of aspects, wherein the solvent is water.

Another aspect is any above aspect or combination of aspects, wherein aging the mixture comprises stirring the mixture at a temperature of from 20° C. to 40° C.

Another aspect is any above aspect or combination of aspects, wherein aging the mixture comprises stirring the mixture for from 10 hours to 30 hours.

Another aspect is any above aspect or combination of aspects, wherein the basic compound is chosen from one or more of NaOH, KOH, or Mg(OH)₂.

Another aspect is any above aspect or combination of aspects, wherein the amount of additional alumina added is the same or different from the amount of alumina source material used to form the mixture.

Another aspect is any above aspect or combination of aspects, wherein the zeolite-Y particles have an average particle size of from 150 nm to 280 nm.

Another aspect is any above aspect or combination of aspects, wherein the zeolite-Y particles have an average pore size of from 2 to 5 nm.

Another aspect is any above aspect or combination of aspects, wherein the zeolite-Y particles have a total pore volume of from 0.45 ml/g to 0.7 ml/g.

Another aspect is any above aspect or combination of aspects, wherein the zeolite-Y particles have an average surface area of at least 600 m²/g.

Another aspect is any above aspect or combination of aspects, wherein the zeolite-Y particles have a relative crystallinity of greater than 75%.

Another aspect is any above aspect or combination of aspects, wherein the method further comprises washing the zeolite-Y particles; drying the zeolite-Y particles; and calcinating the zeolite-Y particles.

Having described the subject matter of the present disclosure in detail and by reference to specific embodiments, it is noted that the various details described in this disclosure should not be taken to imply that these details relate to elements that are essential components of the various embodiments described in this disclosure, even in cases where a particular element is illustrated in each of the drawings that accompany the present description. Rather, the claims appended hereto should be taken as the sole representation of the breadth of the present disclosure and the corresponding scope of the various embodiments described in this disclosure. Further, it will be apparent that modifications and variations are possible without departing from the scope of the appended claims.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that any two quantitative values assigned to a property may constitute a range of that property, and all combinations of ranges formed from all stated quantitative values of a given property are contemplated in this disclosure. It should be appreciated that compositional ranges of a chemical constituent in a stream or in a reactor should be appreciated as containing, in some embodiments, a mixture of isomers of that constituent. For example, a compositional range specifying butene may include a mixture of various isomers of butene. It should be appreciated that the examples supply compositional ranges for various streams, and that the total amount of isomers of a particular chemical composition can constitute a range.

What is claimed is:

1. A method for making zeolite-Y particles, the method comprising:
forming an initial zeolite precursor solution comprising an initial alumina source material and a silica source material in a solvent;
heating the initial zeolite precursor solution at a temperature of at least 50° C. to form an intermediate mixture;
adding additional alumina source material to the intermediate mixture; and
following the adding of the additional alumina source material to the intermediate mixture, heating the intermediate mixture at a temperature of at least 50° C. to form zeolite-Y particles.

2. The method of claim 1, wherein the initial alumina source material is chosen from one or more of NaAlO₂, Al₂(SO₄)₃, Al(NO₃)₃, AlCl₃, or Al₂O₃.

3. The method of claim 1, wherein the additional alumina source material is chosen from one or more of NaAlO₂, Al₂(SO₄)₃, Al(NO₃)₃, AlCl₃, or Al₂O₃.

4. The method of claim 1, wherein the additional alumina source material has the same composition as the initial alumina source material.

5. The method of claim 1, wherein the additional alumina source material has a different composition than the initial alumina source material.

6. The method of claim 1, wherein the method does not utilize an organic structure-directing agent.

7. The method of claim 1, wherein the heating of the initial zeolite precursor solution is at a temperature of from 50° C. to 70° C. for a time period of from 12 hours to 24 hours.

8. The method of claim 1, wherein the heating of the intermediate mixture is at a temperature of from 80° C. to 120° C. for a time period of from 12 hours to 24 hours.

9. The method of claim 1, wherein forming zeolite precursor solution comprises:
mixing a basic compound, the silica source material, and the alumina source material into a solvent to form a mixture; and
aging the mixture by stirring the mixture for at least 10 hours.

10. The method of claim 9, wherein the solvent is water.

11. The method of claim 9, wherein aging the mixture comprises stirring the mixture at a temperature of from 20° C. to 40° C.

12. The method of claim 9, wherein aging the mixture comprises stirring the mixture for from 10 hours to 30 hours.

13. The method of claim 9, wherein the basic compound is chosen from one or more of NaOH, KOH, or Mg(OH)₂.

14. The method of claim 9, wherein the amount of additional alumina added is the same or different from the amount of alumina source material used to form the mixture.

15. The method of claim 1, wherein the zeolite-Y particles have an average particle size of from 150 nm to 280 nm.

16. The method of claim 1, wherein the zeolite-Y particles have an average pore size of from 2 to 5 nm.

17. The method of claim 1, wherein the zeolite-Y particles have a total pore volume of from 0.45 ml/g to 0.7 ml/g.

18. The method of claim 1, wherein the zeolite-Y particles have an average surface area of at least 600 m²/g.

19. The method of claim 1, wherein the zeolite-Y particles have a relative crystallinity of greater than 75%.

20. The method of claim 1, further comprising:
washing the zeolite-Y particles;
drying the zeolite-Y particles; and
calcinating the zeolite-Y particles.
